(19) United States
(12) Patent Application Publication
(10) Pub. No.: US 2016/0063012 A1
(43) Pub. Date: Mar. 3, 2016

(54) MULTI-USER SEARCH OR RECOMMENDATION

(71) Applicant: Neelakantan Sundaresan, Mountain View, CA (US)

(72) Inventor: Neelakantan Sundaresan, Mountain View, CA (US)

(21) Appl. No.: 14/473,934

(22) Filed: Aug. 29, 2014

(51) Int. Cl. G06F 17/30

(52) U.S. Cl. CPC G06F 17/3087

(57) ABSTRACT

Disclosed are a system comprising a computer-readable storage medium storing at least one program, and a computer-implemented method for generating search results. An application interface module receives a first search request linked to first location data of a first user and a second search request linked to second location data of a second user. A search engine determines whether the first and second search requests satisfy a collaboration criterion based at least on the first and second location data. In accordance with a determination that the collaboration criterion is satisfied, the search engine generates a search result based on the first and second search requests. The application interface module provides graphical data for display of the search results within a user interface rendered on a user device.

### TECHNICAL FIELD

Example embodiments of the present application relate generally to processing data and, more particularly in an embodiment, to a system and method for digital searches, recommendations, and/or query suggestions.

### BACKGROUND

A search engine may receive one or more search terms and may generate search results by searching a data set based on the one or more search terms. For example, items of the data set may be selected based on the relevance of the search terms to the respective items. However, due to the nature of textual information, search terms may have multiple meanings or may be ambiguous, which may produce poor quality search results. A variety of methods can be used to improve the accuracy of the search engine. Providing context data to the search engine can provide meaning or context to the search terms. For example, context data may be generated from the user's previous search history or Internet usage.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a network diagram depicting a client-server system, within which one example embodiment may be deployed.

FIG. 2 is a block diagram illustrating a mobile device, according to an example embodiment.

FIG. 3 is a network diagram depicting an example embodiment of an application system including multiple devices forming at least a portion of the client-server system of FIG. 1.

FIG. 4 is a block diagram illustrating an example embodiment of a search system including multiple modules forming at least a portion of the client-server system of FIG. 1.

FIG. 5 is a block diagram illustrating an example data structure for a search system, in accordance with an example embodiment.

FIG. 6 is an interface diagram illustrating an example user interface of a web resource with multiple display elements delivered to user devices by a search system, according to an example embodiment.

FIG. 7 is a flowchart illustrating an example method of generating search results, in accordance with an example embodiment.

FIG. 8 is a flowchart illustrating an example method of evaluating a collaboration criterion, in accordance with an example embodiment.

FIG. 9 is a block diagram of a machine in the example form of a computer system within which instructions may be executed for causing the machine to perform any one or more of the methodologies discussed herein.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the spirit and scope of the disclosure as defined by the appended claims. In the following description, specific details are set forth in order to provide a thorough understanding of the subject matter. Embodiments may be practiced without some or all of these specific details. In addition, well known features may not have been described in detail to avoid unnecessarily obscuring the subject matter.

In accordance with the present disclosure, components, process steps, and/or data structures may be implemented using various types of operating systems, programming languages, computing platforms, computer programs, and/or general purpose machines. In addition, those of ordinary skill in the art will recognize that devices, such as hardwired devices, field programmable gate arrays (FPGAs), application specific integrated circuits (ASICs), or the like, may also be used without departing from the scope and spirit of the concepts disclosed herein. Embodiments may also be tangibly embodied as a set of computer instructions stored on a computer readable medium, such as a memory device.

Example methods and systems for processing search requests, which are embodied on electronic devices, are described. In the following description, for purposes of explanation, numerous specific details are set forth in order to provide a thorough understanding of example embodiments. It will be evident, however, to one skilled in the art that the present inventive subject matter may be practiced without these specific details.

Smart devices are increasingly becoming prevalent in our social lives. These devices often assist users in their activities. For example, a smart device may be used to find a store, a restaurant, a product, a service, real-estate, and the like. Because search engines typically process search requests independent of other users' search requests, work performed on these devices in a group social setting may be assigned to one person, may be divided between friends and/or family members, or may be performed in parallel. As a result, a group of users acting together to search a “web resource” (e.g., a website, web page, or an application employed on a user device) may not be able to collaborate in the search task in an efficient manner. Thus, there is a need for improved search engines.

Example embodiments disclosed herein may take advantage of the fact that multiple users are using a common search engine of a web resource, such as an application executed on computing device or a web page rendered on the computing device. The search engine may recognize conditions that indicate that two users are working together to search for a common object. When the search engine recognizes that the users have a common search goal, the search engine may generate search results, recommendations, and/or query suggestions (collectively referred herein as “search results”) based upon the collective search efforts of the group. This type of searching maybe referred to as collaborative searching, opposed to solitary searching.

In an example embodiment, two co-located user may provide separate search requests to a search system to retrieve common data from a data set. The search system may analyze the separate search requests to determine whether or not the users are searching for a common target. In response to a determination that the users are searching for common target, the search system may operate in a collaboration mode such that the search system performs a search query by combining data from the first search request and the second search request.

In one example embodiment, the same search results are provided to each of the users working in collaboration. For example, the search terms of the first and second search requests may be combined for one search query. In an alternative embodiment, the different search results are provided to each of the users working in collaboration. For instance, separate search queries can be formed from the first and second search requests. A first search query may be formed by using the search terms of the first search request and using the second search request to generate secondary data used for context data. The search results may be provided to the first user. A second search query may be formed by using the search terms of the second search request and using the first search request to generate secondary data used for context data. The search results may be provided to the second user.

The search system can determine if the users are searching for a common goal based on a variety of factors. For example, the search system 400 may compare locations of the requesting users, the similarity of the search requests, the time difference between the first search request and the second search request, and/or the relationship of the users.

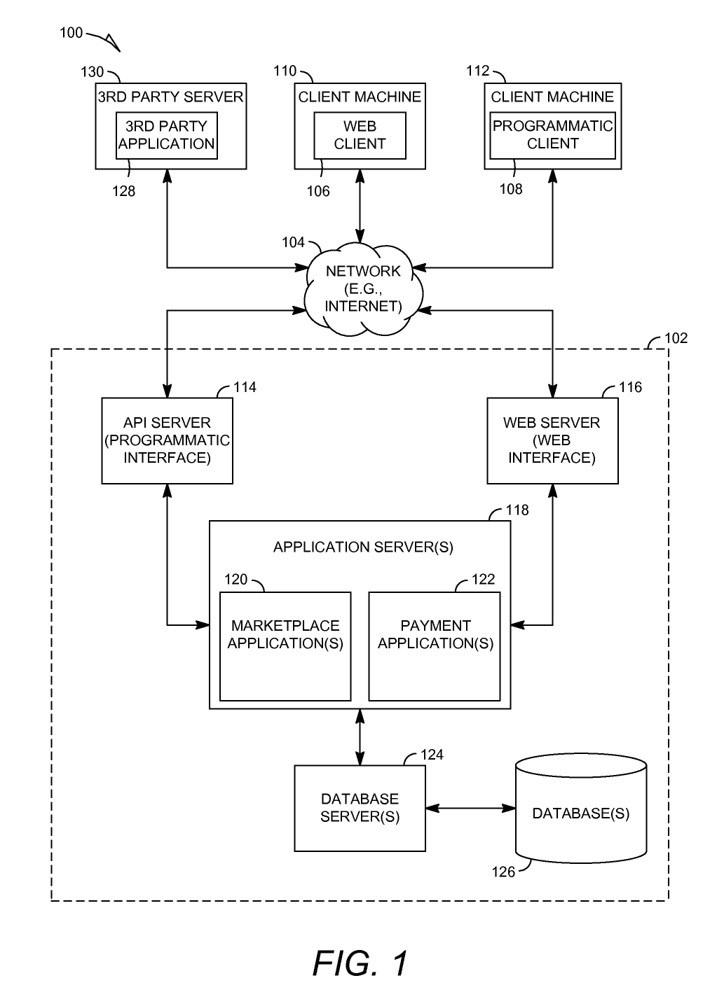

FIG. 1 is a network diagram depicting a client-server system 100, within which one example embodiment may be deployed. A networked system 102, in the example form of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112. Herein, the client machine 110 may be referred to as a “client device” “user device” in various applications.

An Application Program Interface (API) server 114 and a web server 116 are coupled to, and provide programmatic and web interfaces respectively to, one or more application servers 118. The application servers 118 host one or more marketplace applications 120, and payment applications 122. The application servers 118 are, in turn, shown to be coupled to one or more database servers 124 that facilitate access to one or more databases 126.

The marketplace application(s) 120 may provide a number of marketplace functions and services to users that access the networked system 102. The payment application(s) 122 may likewise provide a number of payment services and functions to users. The payment application(s) 122 may allow users to accumulate value (e.g., in a commercial currency, such as the U.S. dollar, or a proprietary currency, such as “points”) in accounts, and then later to redeem the accumulated value for items that are made available via the marketplace application(s) 120.

Further, while the system 100 shown in FIG. 1 employs a client-server architecture, the present inventive subject matter is of course not limited to such an architecture, and could equally well find application in a distributed, or peer-to-peer, architecture system, for example. The various marketplace and payment applications 120, 122 could also be implemented as standalone software programs, which do not necessarily have networking capabilities.

In addition, while the various marketplace and payment applications 120, 122 have been described above as having separate functionalities, in alternative embodiments these functionalities may be performed by any one or more of the various marketplace and payment applications 120, 122.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TURBOLISTER™ application developed by EBAY INC.™, of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

### Example Mobile Device

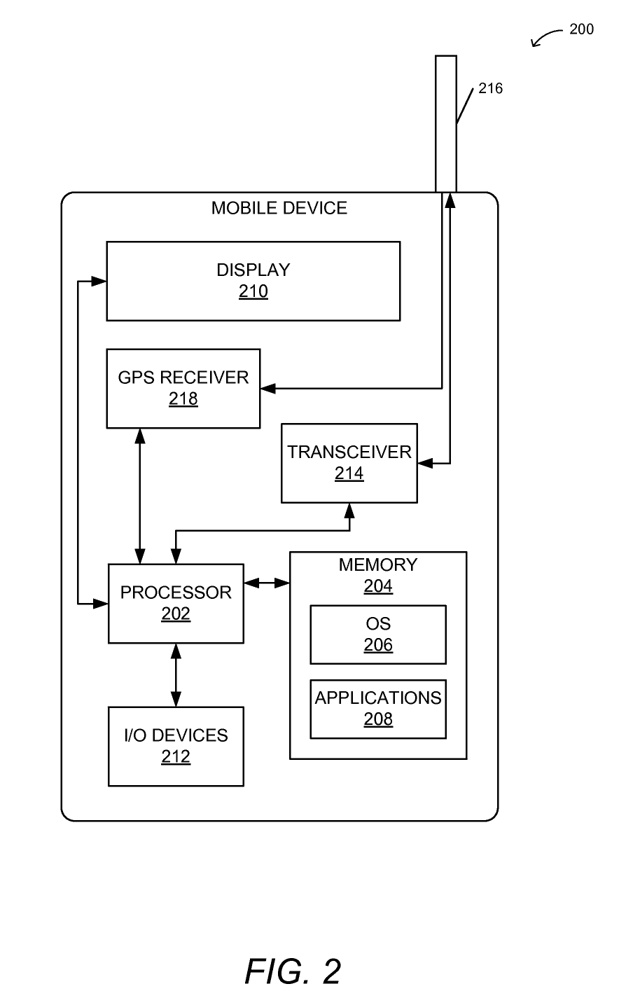

FIG. 2 is a block diagram illustrating a mobile device 200, according to an example embodiment. The mobile device 200 may include a processor 202. The processor 202 may be any of a variety of different types of commercially available processors suitable for mobile devices (for example, an XScale architecture microprocessor, a Microprocessor without Interlocked Pipeline Stages (MIPS) architecture processor, or another type of processor). A memory 204, such as a random access memory (RAM), a Flash memory, or other type of memory, is typically accessible to the processor 202. The memory 204 may be adapted to store an operating system (OS) 206, as well as application programs 208, such as a mobile location-enabled application that may provide Location Based Services (LBSs) to a user. The processor 202 may be coupled, either directly or via appropriate intermediary hardware, to a display 210 and to one or more input/output (I/O) devices 212, such as a keypad, a touch panel sensor, a microphone, and the like. Similarly, in some embodiments, the processor 202 may be coupled to a transceiver 214 that interfaces with an antenna 216. The transceiver 214 may be configured to both transmit and receive cellular network signals, wireless data signals, or other types of signals via the antenna 216, depending on the nature of the mobile device 200. Further, in some configurations, a GPS receiver 218 may also make use of the antenna 216 to receive GPS signals.

### Example Search Systems

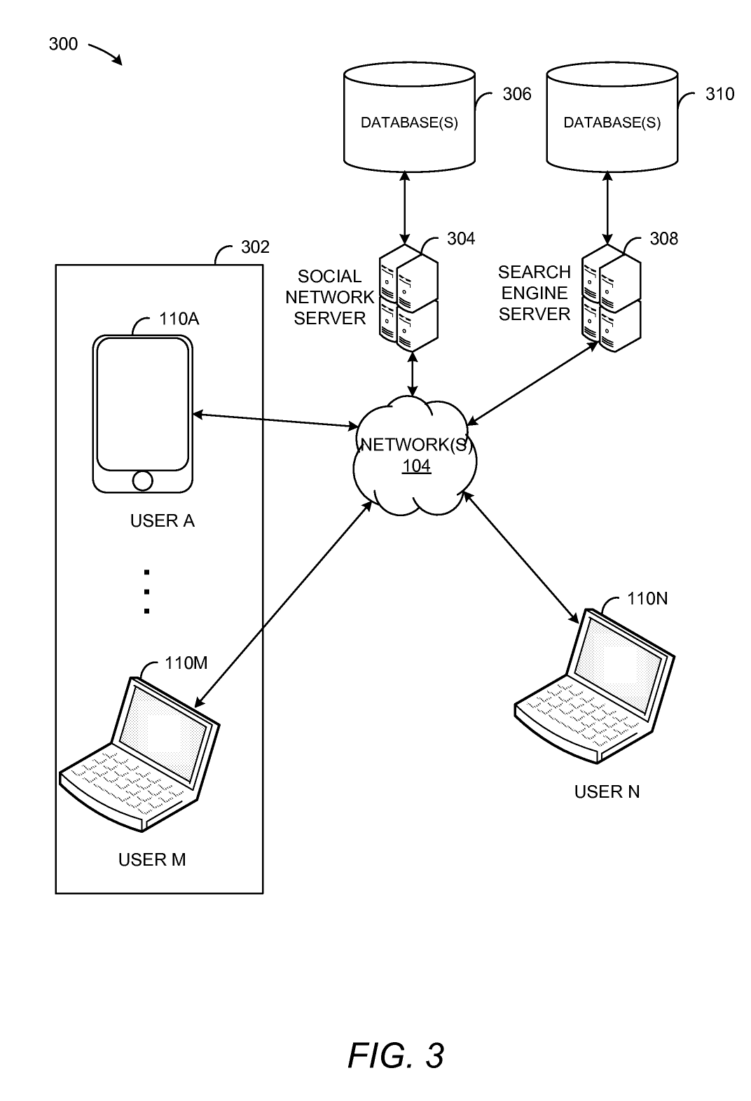

FIG. 3 is a network diagram depicting an example embodiment of an application system 300 including multiple devices forming at least a portion of the client-server system 100 of FIG. 1. The application system 300 may include one or more client machines (or “user devices”) 110A-N. For illustration purposes, the client machines 110A-M are shown to be located within an area of proximity 302 of each other, whereas client machine 110N is shown as being outside of the area of proximity 302. Furthermore, the application system 300 includes a social network server 304 interconnected with a database 306 and a search engine server 308 interconnected with a database 310. The application system 300 includes a network 104 for interconnecting the client machines 110A-N and the servers 304, 308. Each of the client machines 110A-N can correspond to a client machine 110 of FIG. 1. The social network server 304 and the search engine server 308 may each be embodied by one or more of the third-party server 130, client machine 112, or the application server 118 of FIG. 1.

In the illustrated embodiment, the one or more client machines 110A-110N can each correspond to a mobile computing device, a smart phone, a laptop, a desktop computer, a wearable computing device, or any device suitable for communicating with the network 104. The client machines 110A-110N can execute a web resource linked to respective Users A-N. That is, the executed web resource can have data of the identity of the current user, for example, by way of a user log in process. The client machines 110A-110N can communicate web-resource data or code related to the social network server 304 and the search engine server 308 via the network 104. The web resources provided by the client machines 110A-N can include elements for searching, which can be supported, in part, by interfacing with the search engine server 308.

The social network server 304 can correspond to any device for providing social network services. For example, the social network server 304 can form part of a system that provides dedicated social network applications, such as FACEBOOK™, LINKEDIN™, MYSPACE™, INSTAGRAM™, and the like applications. In an alternative embodiment, the social network server 304 can provide social networking features as a service to another application. For example, the social network server 304 can provide services for providing contacts lists, engaging in electronic social activities (private messages, public or semi-public posts, liking content, sharing content, providing ratings/reviews), and the like features of social networks. For instance, the social network server 304 can interface with the web resources executing on the client machines 110A-N and/or the search engine server 308. Data for the social network server 304 can be stored in or retrieved from the database 306.

The search engine server 308 can correspond to any device for providing search and recommendation functionality. The search engine server 308 can be included as part of the application server 118 for facilitating user searches of items, services, and other listings. For example, the search engine server 308 can serve web resources executing on the client machines 110A-N. Data for the search engine server 308 can be stored in or retrieved from the database 310.

In operation, for example, Users A, M, and N of the client machines 110A, 110M, 110N, respectively, can generate separate search requests. The search engine server 308 can determine whether the search requests should be processed in a collaboration mode or a solitary mode. In a collaboration mode, the search engine server 308 can generate search results based on search requests from more than one user. In a solitary mode, the search engine can process the search requests independently.

In an example embodiment, Users A-N (e.g., who can be friends and/or family members) are using a web resource to search for common information to achieve the same task. The search engine server 308 can recognize that the Users A-N have a common goal and can provide improved search results based on multiple search requests. For example, the search engine server 308 can recognize that the search requests from the client machines 110A, 110M are spatially and temporally proximate. That is, the search requests were made close in time and the client machines 110A, 110M are co-located. Accordingly, the search engine can perform collaborative searching for the client machines 110A, 110M. On the other hand, the client machine 110N is outside the area of proximity 302 and thus the search engine server can process the search request of the client machine 110N in a solitary search mode. In alternative embodiments, different factors can be used to determine whether collaborative searches should be used, as will be described in greater detail.

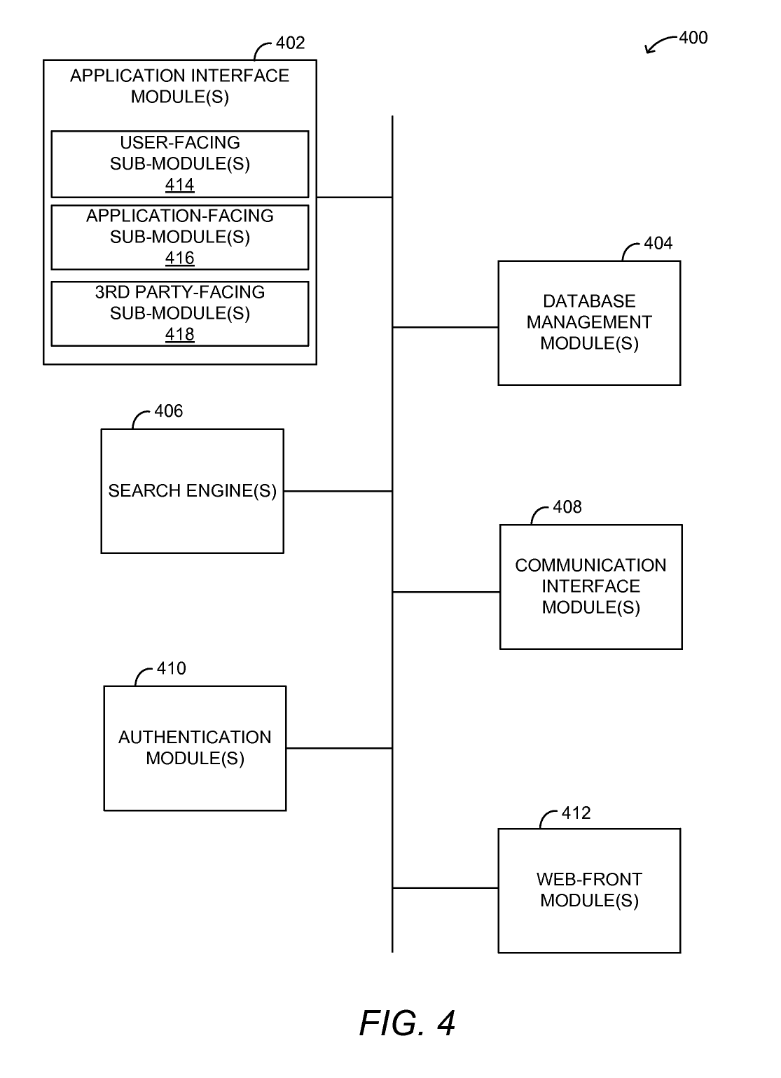

FIG. 4 is a block diagram illustrating an example embodiment of a search system 400 including multiple modules forming at least a portion of the client-server system 100 of FIG. 1. The modules 402-412 of the illustrated search system 400 include an application interface module(s) 402, a database management module(s) 404, a search engine module(s) 406, a communication interface module(s) 408, an authentication module(s) 410, and a web-front module(s) 412. The application interface module(s) 402 includes a user-facing sub-module(s) 414, a vendor-facing sub-module(s) 416, and a third-party facing sub-module(s) 418.

In some embodiments, the components of the search system 400 can be included in the marketplace application 120 of FIG. 1. However, it will be appreciated that in alternative embodiments, one or more components of the search system 400 described below can be included, additionally or alternatively, in other devices, such as one or more of the payment application 122, the servers 114, 116, 118, 130, the network 104, and/or the client machines 110, 112 of FIG. 1.

The modules 402-412 of the search system 400 can be hosted on dedicated or shared server machines (not shown) that are communicatively coupled to enable communications between server machines. Each of the modules 402-412 are communicatively coupled (e.g., via appropriate interfaces) to each other and to various data sources, so as to allow information to be passed between the modules 402-412 of the search system 400 or so as to allow the modules 402-412 to share and access common data. The various modules of the search system 400 can furthermore access one or more databases 126 via the database server(s) 124.

The server system 400 can facilitate receiving search requests, processing search queries, and providing search results on client machines. In particular, the search system 400 can receive separate search requests from user devices and determine whether to process the search requests in a collaboration mode or in a solitary mode. To this end, the search system 400 is shown to include application interface module(s) 402, a database management module(s) 404, a search engine module(s) 406, a communication interface module(s) 408, an authentication module(s) 410, and a web-front module(s) 412, which can serve to provide collaborative searches.

The application interface module(s) 402 can be a hardware-implemented module which can be configured to communicate data with client devices. From the perspective of the search system 500, client devices can include user devices, such as client machine 110 of FIG. 1, and/or vendor devices, such as application server(s) 118 of FIG. 1. The user-facing sub-module(s) 414 can interface with user devices. The application-facing sub-module(s) 416 can interface with web resources. The third-party-facing sub-module(s) 418 can interface with third party applications. In example embodiments, the search system 300 can interface with third-party applications that provide services such as searching and/or data storage. Accordingly, the search system 400 can provide collaborative searching by modifying its interactions with the third applications.

In operation, the application interface module(s) 402 can receive search requests, each linked to a user and/or location data. The application interface module(s) 402 can provide users the search results.

The database management module(s) 404 can be a hardware-implemented module which can provide data storage and/or access. The database management module(s) 404 can interface with the database 126 of FIG. 1 or the database 310 of FIG. 3.

The search engine(s) 406 can be a hardware-implemented module which can facilitate searching. As will be described in greater detail, the search engine(s) 406 can determine whether the first and second search requests satisfy a collaboration criterion. This determination can be based at least on the locations of the requesting users. If the collaboration criterion is satisfied, the search engine(s) 406 can generate a collaborative search result based on the first and second search requests.

In an example embodiment, the search engine(s) 406 can perform the search query. In an alternative embodiment, the search engine(s) 406 determines search results by processing the search requests and by providing the processed search requests to a search service, such as a third-party search engine, to perform the searching. The processing can include combining two or more search requests into a single (combined) search request suitable for the third-party search engine.

The communication interface module(s) 408 can be a hardware-implemented module which can facilitate the flow of the information, data, and/or signals between the modules 402-412. In addition, the communication module(s) 508 can be configured to support communication of the digital inventory system 500 between the servers and client machines of FIG. 1. For instance, the communication interface module(s) 508 can be configured to provide a response message including the model data to display the digital avatar on a user device.

The authentication module(s) 410 can be a hardware-implemented module which can facilitate authentication of data provided from user devices and vendor devices. The authentication module(s) 410 can serve to facilitate registering users.

The web-front module(s) 412 can be a hardware-implemented module which can provide data for displaying web resources on client devices. For example, the search system 400 can provide a webpage for users and vendors to log in and create accounts and update the account information. The web-front module(s) 412 can provide user interfaces for users to provide social networking log-in information. The authentication module(s) 410 can be used to register users for access to account data.

### Example Data Structures

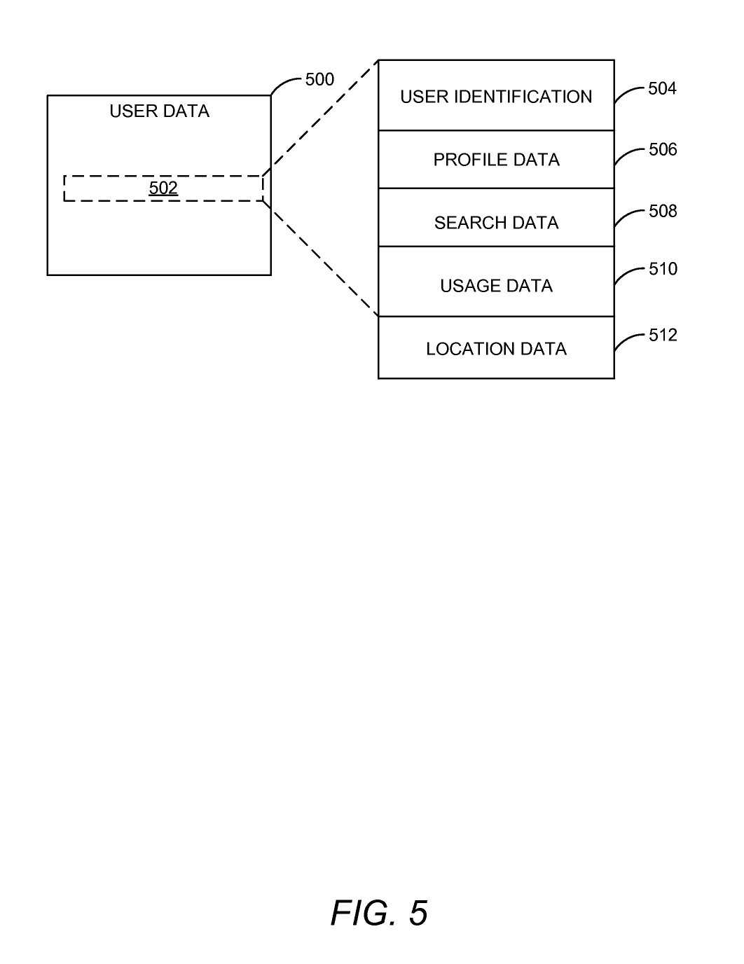

FIG. 5 is a block diagram illustrating an example user data structure 500 for a search system 400, in accordance with an example embodiment. The data structure 500 can include data for one or more users. For instance, data entry 502 can be associated with a particular user. The data entry 502 can include a user identification data field 504, a profile data field 506, a search data field 508, a usage data field 510, and a location data field 512. Although the data structure 500 is shown in FIG. 5 as being contiguous region of data, in alternative embodiments the data structure 500 can be distributed throughout memory or among a plurality of devices. It will be appreciated that alternative embodiments can use more or fewer data elements than the data elements shown in FIG. 5.

In operation, the search engine(s) 406 can access the data entry 502 to process a search request from a user associated with the user identification data field 504. The search engine(s) 406 can access the data entry 502 by receiving at least a portion of the data entry 502 from the client machine 110 of the requesting user and/or by accessing previously stored data, such as data in a database 310 of FIG. 3. For example, the client machine 110 can transmit to the search system 400 cookie data that includes at least a portion of the data entry 502. Additionally or alternatively, the search engine(s) 406 can use the database management module(s) 404 to access data associated with the requesting user. For example, the search request can include identification data for matching to the user identification data field 504 to select the corresponding data entry 502.

As stated above, the user identification data field 504 of the data entry 502 can correspond to data usable to identify a user. For example, each user can have a unique username or code to identify the corresponding data entry 502. In this way, the username or code can be matched to the data field 504 to determine whether or not the data structure 502 corresponds to a particular user. Furthermore, the user identification data field 504 can include data useable to access user data stored by other applications, such as locating social networking data related to the user by interfacing with a social network application (e.g., the social network server 304 of FIG. 3).

The profile data field 612 of the data entry 502 can correspond to information related to the user, such as the user's name, residence, occupation, and the like. Additionally or alternatively, the profile data field 506 can include data links or pointers to social network profiles of the user. As such, the profile data field 506 can include authentication data (e.g., a log-in and password data) for accessing the user's social network profile data. Additionally or alternatively, the profile data field 506 can include search preferences, such as a preference for enabling collaborative searches.

In an example embodiment, the profile data field 506 can include attribute data suitable for adjusting performance of the search engine(s) 406. For example, the search engine(s) 406 can track user responses to search results in order to adjust parameters of subsequent search queries for that user. For example, the search engine 406 can adjust parameters based on positive responses (e.g., user selects an item of the search results) or negative responses (e.g., the user does not select an item of the search results). For example, the search engine 406 may, for a particular user, adjust the criterion for selecting collaborative search so that collaborative search is less favored in response to negative responses by the user to collaborative search results, and can adjust the criterion for selecting collaborative search so that collaborative search is more favored in response to positive responses by the user to collaborative search results. Parameters that can affect the selection of collaborative searching are sensitivities to distance between users, differences between the time of the search requests, the relatedness of the search terms of the search requests, the connectedness of the users based on social network data, and the like. Accordingly, in an example, the search engine(s) 406 can select solitary searching for a first user unless other users are within 3 feet and can select solitary searching for a second user unless other users are within 10 feet.

The search data field 508 of the data entry 502 can correspond to data related to previous search history of the user. The usage data field 510 of the data entry 502 can correspond to data related to previous activities performed by the user. For example, the client machine 110 of the user can monitor activities, such as web browsing information, which is stored in the usage data field 510. The search engine(s) 406 can use information about previous searches and usage activities to improve performance of the search engine(s) 406.

The location data field 512 of the data entry 502 can correspond to data related to the user's location. For example, the client machine 110 can provide location information to the search system 400 in connection with providing the search system 400 with a search request. As will be described below in greater detail, the search engine(s) 406 can use the location information to determine whether to process a search request in a collaboration mode.

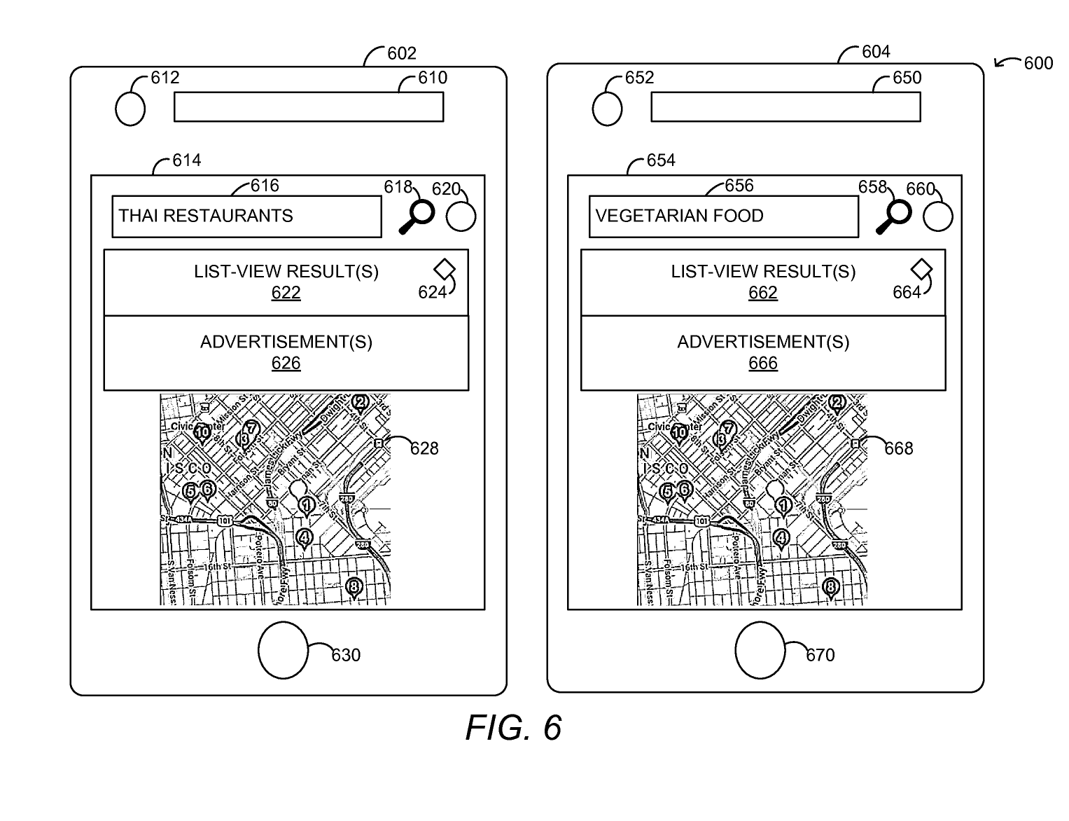

FIG. 6 is an interface diagram 600 illustrating example user interfaces of a web resource with multiple display elements delivered to user devices 602, 604 by a search system 400, according to an example embodiment. In the illustrated example embodiment of FIG. 6, a first device 602 and a second device 604 each are providing separate search requests to the search system 400. The first device 602 can include an audio input-output element 610, a camera 612, and a display 614. As shown, the display 614 can render graphical element 616-628 to form a user interface. Additionally, the first device 602 can include an input-output control 630, such as a selectable physical button, to control operation of the first device 602. Likewise, the second device 604 can include an audio input-output element 650, a camera 652, and a display 654. The display 654 can render graphical elements 656-668 as a user interface. Additionally, the second device can include the input output control 670, such as a selectable physical button.

For illustration purposes only, and not by way of limitation, FIG. 6 illustrates a use case in which co-located first and second users are searching for a restaurant to have lunch together. As will be described in greater detail below, the first user, using the first device 602, searches for a “Thai Restaurant” using a web resource. A second user, using the second device 604, searches for “Vegetarian Restaurant” using the web resource. The search system 400 can search for vegetarian Thai restaurants and push the search result to both users. It will be appreciated that while FIG. 6 is described in the context of restaurants, alternative embodiments are not limited to search for restaurants and can search for information related to shopping, places, travel, real estate, and the like.

For the sake of brevity, the graphical elements 616-628 and 656-668 will be described primarily in the context of the graphical elements 616-628 of the first device 602. It will be understood that the description is also applicable to the counterpart graphical elements 656-668 of the second device 604.

The graphical element 616 of the frame display 614 can correspond to a text box to receive search terms for a search query, such as “THAI RESTAURANTS” as shown in FIG. 6. The graphical element 618 can correspond to a selectable user interface element to initiate a search using the text entered in the graphical element 616. The graphical element 620 can correspond to a selectable user interface element to toggle on and off collaborative search mode.

For example, in operation, the first user can select the graphical element 620 to turn on collaborative search mode. In response to the first user selecting the graphical element 620, the first device 602 can provide the search system 400 control data to turn on collaborative searches for the first user. As such, in response to receiving a search request from the first user, the search system 400 can determine whether there are search requests from other users to combine with the search request of the first user. For example, the search system 400 can determine that the search request for “VEGETARIAN FOOD” from the second user should be used to with the search request for “THAI RESTAURANTS” from the first user. In an example embodiment, in response to the first user turning on the collaborative search mode while the display 614 is rendering solitary search results, the search system 400 can automatically update the search results to display the corresponding collaborative search results.

Likewise, the first user can select the graphical element 620 to turn off collaborative searches so that the search system 400 does not combine the search requests of the first user with search requests from other users. In an example embodiment, in response the first user turning off the collaborative search mode while the display 614 is rendering collaborative search results, the search system 400 can update the search results automatically to display the solitary search results.

In an example embodiment, in response to the first user activating collaborative search mode, the search system 400 can request that the first user select one or more contacts (e.g., the second user) to include in collaborative searches. For example, a list (not shown) of contacts can be generated based on social network data of the first user. In an example embodiment, a selected contact can receive a prompt to approve the first user's request before being included in collaborative searches. In an alternative embodiment, the search system 400 does not prompt the first user to select contacts. Rather, the search system 400 automatically determines whether other search requests are included in collaborative searches based on one or more considerations, such as spatial proximity to the user, relatedness of the search terms, temporal proximity the search requests, linking data of social network, and/or the like.

The graphical element 622 of the display 614 can correspond to a frame element to display search results in a list-view format. In an example embodiment, the graphical element 622 can include the graphical element 624 for providing a graphical indication of whether the results were generated using data from another user's search request, for instance, in collaboration mode. The search system 400 can provide graphical data to the first device 602 to change the appearance of the graphical element 624, such as to change the highlighting, color, or the like visual characteristics of the graphical element 624 to indicate collaborative mode operation. The graphical element 624 can serve as a graphical feedback. This indication can be useful because even in collaborative mode the search results can correspond to solitary search results if the search engine(s) 406 does not determine another search request to combine with the search request of the first user.

The graphical element 626 of the display 614 can correspond to a frame element to display advertisements and/or recommendations. In one aspect, the search system 400 can facilitate selecting data to populate the graphical element 626. The content can be selected based on search requests from the first user. Additionally or alternatively, in an example embodiment, the search system 400 can select the content based on search requests from another user included in a collaboration search with the first user.

The graphical element 628 of the display 614 can correspond to a frame element to display a map view of the search results. Additionally or alternatively, the graphical element 628 can also display graphical indications (not shown) of contacts of the first user who are located within a range of the user. The user can select a graphical indication of a particular user to toggle whether or not that user is included in collaborative searching with the first user. For example, toggling off a contact who was previously included in a collaborative search can cause the search results displayed in the graphical element 622, 628 to automatically update in response removing the selected contact. Likewise, adding a contact can cause the graphical element 622, 628 to the automatically update to include the contact's search request.

An example embodiment, a user can select items of a search result displayed in either of the graphical element 622, 628 to remove, highlight, or annotate the selected item from the search results. In responses to the user's selection, the item can also be automatically updated in a similar manner in the search results displayed on the devices of the users included in the collaborative search.

In an example embodiment, the first user can use the audio input-output element 610 and/or the camera 612 of the first device 602 to communicate with the second user or any other user included in the collaborative searching. For example, the camera 612 can be used to create a video feed that is communicated to the second device 604. Providing such communication channels can aid in improving collaboration between the first and second users, particularly where the first and second users are located a large distance from each other.

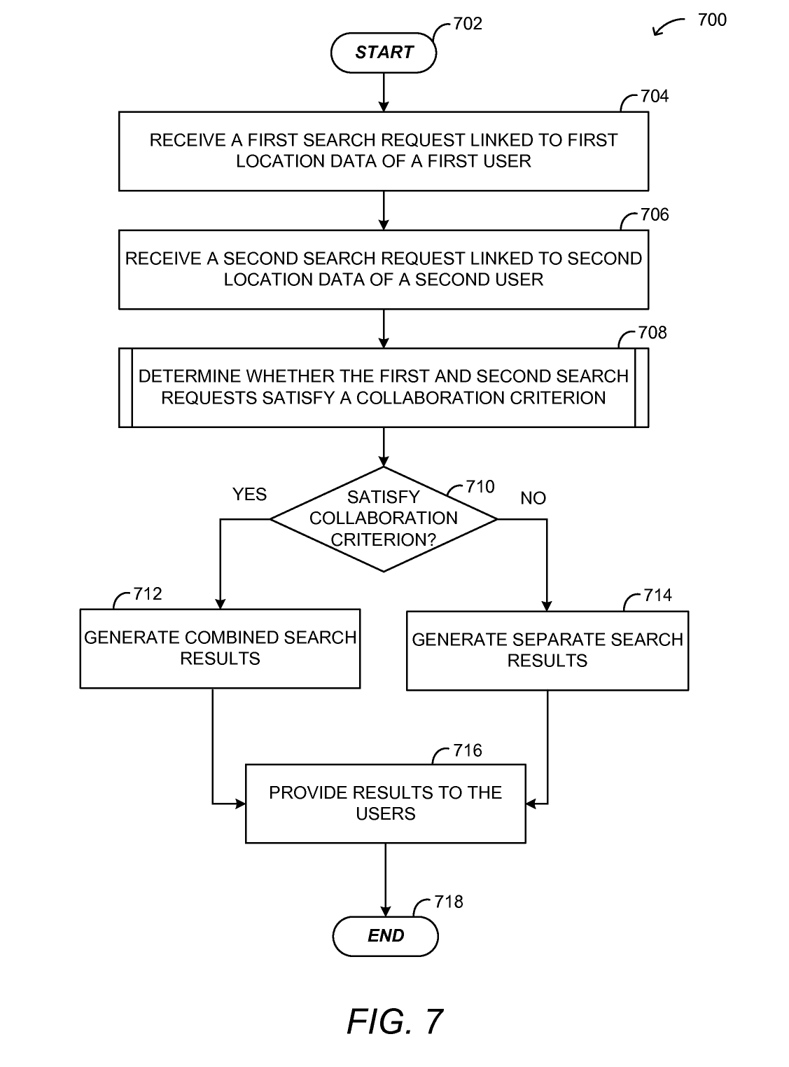

FIG. 7 is a flowchart illustrating an example method 700 of generating search results, in accordance with an example embodiment. By way of example, the search results will be described in context of search query results. It will be appreciated, however, that the search results can additionally or alternatively include recommendations and/or search query suggestions.

In this example, the method 700 can include operations such as receiving a first search request linked to first location data of a first user (block 704), receiving a second search request linked to second location data of a second user (block 706), determining whether the first and second search requests satisfy a collaboration criterion (block 708), generating combined search results (block 712), generating separate search results (block 714), and providing results to the users (block 716). The example method 700 will be described below, by way of explanation, as being performed by certain modules. It will be appreciated, however, that the operations of the example method 700 can be performed in any suitable order by any number of the modules shown in FIG. 4.

The method 700 starts at block 702 and proceeds to blocks 704, 706 for receiving first and second search requests, each request being linked to location data of respective users. For example, a first user can provide the search system 400 the first search request. The search request can include a user identifier and a location identifier, such as the coordinates of the first user. Likewise, a second user can provide to the search system 400 the second search request. The second search request can include a user identifier and a location identifier, such as the coordinates of the second user. The application interface module(s) 402 of the search system 400 can receive the first and second search requests.

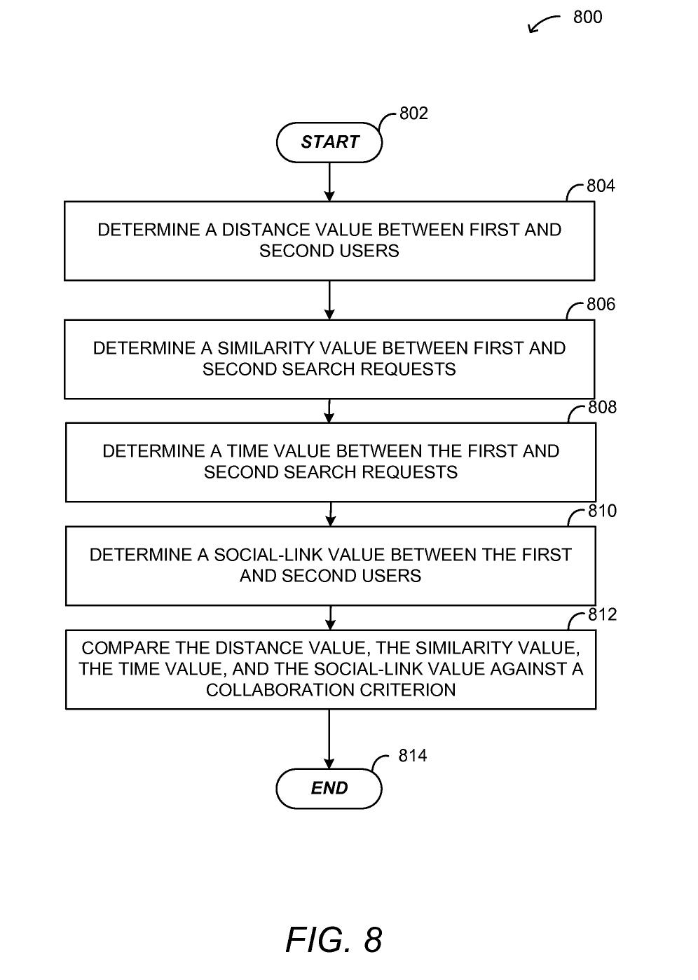

At block 708, the method 700 can include determining whether the first and second search requests satisfy a collaboration criterion. For example, the search engine(s) 406 can compare the first and second search results to determine the “proximity” or “closeness” of the search requests. For example, where the search requests are close in terms of space, time, objectives (e.g., search terms), users, etc., the search engine(s) 406 can determine to process the first and second search requests in collaborative mode. The collaboration criterion provides a definition of how to determine “closeness” and what is “close.” An example method of block 708 will be described below in greater detail in connection with FIG. 8.

At block 710, the method 700 can proceed to block 712 based on a determination that the collaboration criterion is satisfied, or can proceed to block 714 based on a determination that the collaboration criterion is not satisfied. At block 712, the method 700 can include generating combined-requests search results (e.g., “collaborative search results”). For example, the search engine(s) 406 can perform a search query by combining the search terms of the first and second search requests. In an example alternative embodiment, the search engine(s) 406 can generate the collaborative search results by generating context data from the second search request and by performing a search query using the search terms of the first search request and the context data. In another example embodiment, the search engine(s) 406 can generate the collaborative search results by performing a search query using the search terms of the first search request and including the search terms of the second search request as part of the user's search history data (e.g., combining data of the second search request and the search data field 508 of FIG. 5). Context data and previous search data can be used by the search engine(s) 406 to improve the accuracy of the search query.

In an example embodiment, the search engine(s) 406 tests the quality of the collaborative search results in order to determine whether the quality of the collaborative search results represents an improvement over a solitary search results. In response to a determination that the quality of the collaborative search results is an improvement, the search engine(s) 406 can select the collaborative search results. In response to a determination that the quality is less than the quality of the solitary search results, the search engine(s) 406 can replace the collaborative search results with the solitary search results.

At block 714, in accordance with a determination that the collaboration criterion is not satisfied, the method 700 can include generating separate search results (e.g., “solitary search results”). For example, the search engine(s) 406 can process the first and second search request independently to generate two separate search results.

At block 716, the method 700 can include providing the search results generated at either block 712 or block 714 to the users. In an example embodiment, the items of the search results may include data or code for tracking user responses. At block 718, the method 700 can end.

In an example embodiment, the search engine 406 can track user responses to the provided search results in order to adjust the collaboration criterion. For example, the search engine(s) 406 can reduce the threshold or scoring of the collaboration criterion in response to positive responses to collaborative search results (e.g., generated at block 712) and/or negative responses to solitary search results (e.g., generated at block 714). Additionally or alternatively, the search engine(s) 406 can increase the threshold or scoring of the collaboration criterion in response to negative responses to collaborative search results and/or positive responses to solitary search results (e.g., generated at block 714). The adjustment of the threshold can correspond to an adjustment of the overall threshold of the collaboration criterion or to the weighting factors or the threshold of one or more individual factors (e.g., distance between users, timing between requests, or the like factors described in connection with FIG. 8) of the collaboration criterion.

In an example embodiment, the search engine(s) 406 can omit block 710 and instead generate both collaboration search results and solitary search results at blocks 712, 714. Furthermore, the search results provided to the user at block 718 can include a combination of the two search results types. The ratio of the combination can be determined based on the level of satisfaction of the collaboration criterion, where higher levels can result in a higher proportion of the collaboration search results. The search engine(s) 406 can track user responses to the combination of the two search results types and based on the user responses adjust the proportion for future search results. For example, receiving positive (negative) responses to items of the collaborative search results can cause the search engine(s) 406 to adjust a parameter to increase (decrease) the proportion of the collaborative search results in a subsequent search. In an example embodiment, the adjusted parameter may be stored in the profile data field 506 of FIG. 5.

FIG. 8 is a flowchart illustrating an example method 800 of evaluating a collaboration criterion, in accordance with an example embodiment. In an example embodiment, the method 800 can be performed at block 708 of FIG. 7. In this example, the method 800 can include operations such as determining a distance value between first and second users (block 804), determining a similarity value between first and second search requests (block 806), determining a time value between the first and second search request (block 808), determining a social link between the first and second users (block 810), and comparing the distance value, the similarity value, the time value, and the social link value against a collaboration criterion (block 812). The example method 800 will be described below, by way of explanation, as being performed by certain modules. It will be appreciated, however, that the operations of the example method 800 can be performed in any suitable order by any number of the modules shown in FIG. 4.

The example method 800 starts at block 802 and proceeds to block 804 for determining a distance value between first and second users. For example, the first and second users can provide first and second search requests, respectively, to the search system 400. The first and second search requests can include location data that identifies locations of the first and second user. Accordingly, the search engine(s) 406 can determine the distance value as a distance between the first and second users. In an example embodiment, a small distance value between the first and second users can weigh in favor of performing a collaborative search rather than a solitary search.

At block 806, the method 800 can include determining a similarity value between first and second search requests. For example, each of the first and second search requests can include one or more search terms. As such, the search engine(s) 406 can determine the similarity value of the first and second search requests by comparing the search terms using a “search engine dictionary.” In an example embodiment, a search engine dictionary can be usable to quantify similarities between search terms. A large similarity value between the search terms of the first and second search requests can weigh in favor of performing a collaborative search rather than a solitary search.

At block 808, the method 800 can include determining a time value between the first and second search requests. For example, the search engine(s) 406 can determine the time value by determining the time difference between receiving the first search request and receiving the second search request, or the time difference between the first user sending the first search request and the second user setting the second search request. A small time value between the first and second search requests can weigh in favor of performing a collaborative search rather than a solitary search.

At block 810, the method 800 can include determining a social-link value between the first and second users. For example, the search engine(s) 406 can access the profile data field 506 of FIG. 5 to retrieve social network data related to the first and second users. The social-link value can be a binary value, such as a HIGH value if the first and second users are connected in a social network and a LOW value otherwise. In an alternative example embodiment, the social-link value can be the multi-valued (e.g., more than two) based on the degree of the connection. For example, a first-degree connection can result in a high-value of the social-link value, a second-degree connection can results can comparatively lower value, and so on. A large social-link value between the first and second search requests can weigh in favor of performing a collaborative search rather than a solitary search

At block 812, the method 800 can include comparing the distance value, the similarity value, the time value, and the social link value against a collaboration criterion. In an example embodiment, the collaboration criterion can be based on a threshold operation performed on each of the determined values. If each of the values meets its respective threshold value, the search engine(s) 406 can perform a collaborative search. Otherwise, the search engine(s) 406 can perform solitary searches.

In alternative embodiments, the search engine(s) 406 determines a value of the collaboration criterion (e.g., a “level of satisfaction) based on the first and second search requests. One example of a level of satisfaction is a weighted combination (e.g., sum) of the determined values. The level of satisfaction can be used to make a binary decision to use collaboration searching or to use solitary searching. For instance, the level of satisfaction can be compared against a threshold value. In accordance with a determination that the weighted sum is greater than the threshold value, then the search engine(s) 406 can perform a collaborative search. Otherwise, the search engine(s) 406 can perform solitary searches. In alternative embodiments, as stated, the search engine(s) 406 may use the level of satisfaction to select a ratio of collaborative search items and solitary search items to return to the requesting user.

It will be appreciated that in alternative embodiments that the search engine(s) 406 does not determine and/or use each of the distance value, similarity value, time value, or the social link value for evaluating the collaboration criterion. For example, in an example embodiment, the search engine(s) 406 does not use social networking data and thus the social-link value is not determined.

In an alternative embodiment, the search engine(s) 406 omits the method 800 or the block 708 of FIG. 7 in response to user input, such as, but not limited to, user input that explicitly turns on or off collaborative searching. An example was described above in connection with FIG. 6.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

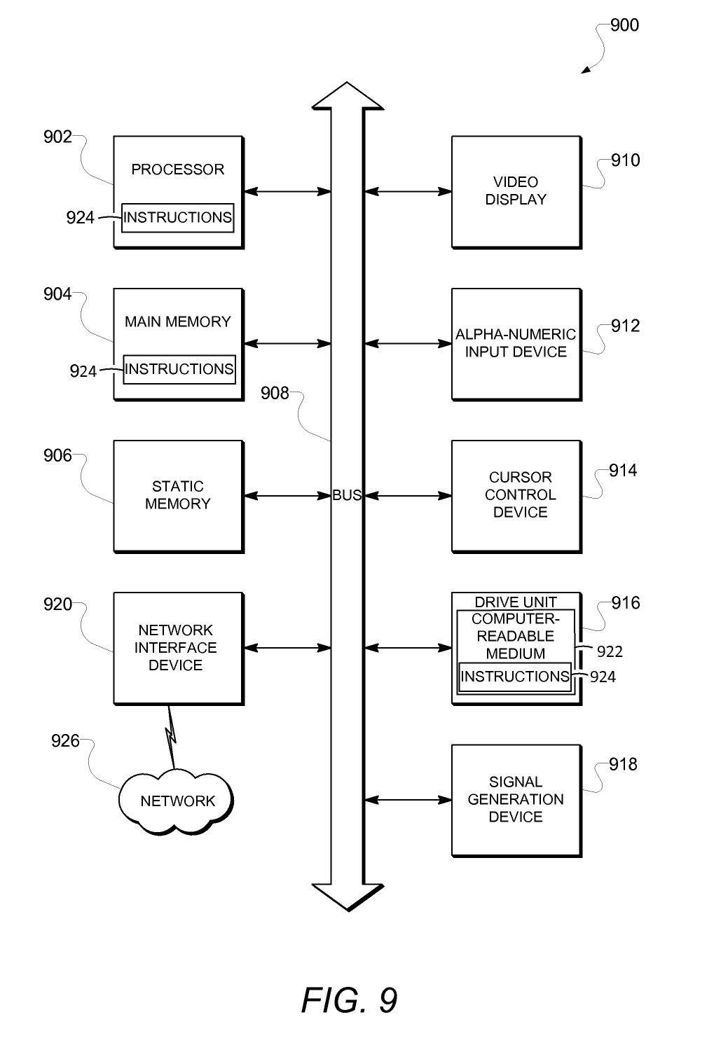

FIG. 9 is a block diagram of a machine in the example form of a computer system 900 within which instructions 924 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a computer-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the computer-readable medium 922 is shown in an example embodiment to be a single medium, the term “computer-readable medium” may include a single medium or multiple media (e.g., a centralized or distributed database, and/or associated caches and servers) that store the one or more instructions 924 or data structures. The term “computer-readable medium” shall also be taken to include any non-transitory, tangible medium that is capable of storing, encoding or carrying instructions 924 for execution by the machine and that cause the machine to perform any one or more of the methodologies of the present inventive subject matter, or that is capable of storing, encoding or carrying data structures utilized by or associated with such instructions. The term “computer-readable medium” shall accordingly be taken to include, but not be limited to, solid-state memories, and optical and magnetic media. Specific examples of computer-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions (e.g., instructions 924) for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent to those of skill in the art upon reviewing the above description.

What is claimed:

1. A system comprising:
an application interface module configured to receive a first search request linked to first location data of a first user and a second search request linked to second location data of a second user; and
a search engine, including one or more processors, configured to:
based at least on the first and second location data, determine whether the first and second search requests satisfy a collaboration criterion; and
in accordance with a determination that the collaboration criterion is satisfied, generate a search result based on the first and second search requests, the application interface module being further configured to provide graphical data for display of the search results within a user interface rendered on a user device.

2. The system of claim 1, wherein the search engine is configured to determine whether the first and second search requests satisfy a collaboration criterion by:
determining a distance value between the first and second users;
determining a similarity value between the first and second search requests; and
comparing the distance value and the similarity value with the collaboration criterion.

3. The system of claim 2, wherein the search engine is configured to determine whether the first and second search requests satisfy a collaboration criterion by further:
determining a time value between the first and second search requests; and
comparing the distance value, the similarity value, and time value with the collaboration criterion.

4. The system of claim 2, wherein the search engine is configured to determine whether the first and second search requests satisfy a collaboration criterion by further:
determining a social-link value between the first and second users; and
comparing the distance value, the similarity value, and social-link value with the collaboration criterion.

5. The system of claim 1, wherein the search engine is further configured to process the first and second search requests separately in accordance with a determination that the collaboration criterion is unsatisfied.

6. The system of claim 1, wherein the determining of whether the first and second search requests satisfy the collaboration criterion is in response to receiving the first and second search requests.

7. The system of claim 1, wherein the search results include at least one of a query result, a recommendation, or a query suggestion.

8. The system of claim 1, wherein the application interface module is further configured to provide a graphical element for display within a user interface rendered on the user device, the graphical element being selectable to activate a collaborative search mode.

9. The system of claim 1, wherein the application interface module is further configured to provide a graphical indication for display within a user interface rendered on the user device, the graphical indication indicating that the search engine used data from another search request.

10. The system of claim 1, wherein the search engine is configured to generate the search results by:
generating context data from the first search request; and
executing a search query based on the first search request and the context data to generate the search results.

11. The system of claim 1, wherein the search engine is further configured to receive a user response to the search response, the search engine being further configured to adjust the collaboration criterion based on the received user response.

12. A computer-implemented method, the method comprising:
receiving a first search request linked to first location data of a first user and a second search request linked to second location data of a second user;
determining, by one or more processors and based at least on the first and second location data, whether the first and second search requests satisfy a collaboration criterion; and
in accordance with a determination that the collaboration criterion is satisfied, generating a search result based on the first and second search requests; and
providing graphical data for display of the search results within a user interface rendered on a user device.

13. The computer-implemented method of claim 12, wherein the determining of whether the first and second search requests satisfy a collaboration criterion comprises:
determining a distance value between the first and second users;
determining a similarity value between the first and second search requests; and
comparing the distance value and the similarity value with the collaboration criterion.

14. The computer-implemented method of claim 13, wherein the determining of whether the first and second search requests satisfy a collaboration criterion comprises:
determining a time value between the first and second search requests; and
comparing the distance value, the similarity value, and time value with the collaboration criterion.

15. The computer-implemented method of claim 13, wherein the determining of whether the first and second search requests satisfy a collaboration criterion comprises:
determining a social-link value between the first and second users; and
comparing the distance value, the similarity value, and social-link value with the collaboration criterion.

16. A machine-readable storage medium embodying instructions that, when executed by a machine, cause the machine to perform operations comprising:
receiving a first search request linked to first location data of a first user and a second search request linked to second location data of a second user;
determining, by one or more processors and based at least on the first and second location data, whether the first and second search requests satisfy a collaboration criterion; and
in accordance with a determination that the collaboration criterion is satisfied, generating a search result based on the first and second search requests; and
providing graphical data for display of the search results within a user interface rendered on a user device.

17. The machine-readable storage medium of claim 16, wherein the determining of whether the first and second search requests satisfy a collaboration criterion comprises:
determining a distance value between the first and second users;
determining a similarity value between the first and second search requests; and
comparing the distance value and the similarity value with the collaboration criterion.

18. The machine-readable storage medium of claim 17, wherein the determining of whether the first and second search requests satisfy a collaboration criterion comprises:
determining a time value between the first and second search requests; and
comparing the distance value, the similarity value, and time value with the collaboration criterion.

19. The machine-readable storage medium of claim 17, wherein the determining of whether the first and second search requests satisfy a collaboration criterion comprises:
determining a social-link value between the first and second users; and
comparing the distance value, the similarity value, and social-link value with the collaboration criterion.

20. The machine-readable storage medium of claim 18, further embodying instructions that, when executed by the machine, cause the machine to perform operations comprising:
processing the first and second search requests separately in accordance with a determination that the collaboration criterion is unsatisfied.
